(19) United States
(12) Patent Application Publication
(10) Pub. No.: US 2026/0145190 A1
(43) Pub. Date: May 28, 2026

(54) SPRAY NOZZLE AND METHOD FOR THERMAL SPRAYING

(71) Applicant: ROLLS-ROYCE plc, London (GB)

(72) Inventors: Siddharth LOKACHARI, Derby (GB); Tanvir HUSSAIN, Derby (GB)

(73) Assignee: ROLLS-ROYCE plc, London (GB)

(21) Appl. No.: 19/371,656

(22) Filed: Oct. 28, 2025

(30) Foreign Application Priority Data
Nov. 27, 2024 (GB) 2417382.5

(51) Int. Cl. B05B 7/20; B05B 13/00

(52) U.S. Cl. CPC B05B 7/201; B05B 13/00

(57) ABSTRACT

A spray nozzle for thermal spraying a coating material on a substrate includes a central port configured to deliver the coating material along a spray axis in the form of an atomized suspension. The spray nozzle further includes a plurality of gas ports arranged symmetrically and peripherally around the central port with respect to the spray axis. Each gas port is configured to deliver a pressurized combustible gas for entraining the coating material after the coating material has exited the central port. The pressurized combustible gas is configured to heat the coating material in a heating zone for generating a heated gas stream. The heated gas stream is directed toward a target surface of the substrate.

### CROSS-REFERENCE TO RELATED APPLICATIONS

This specification is based upon and claims the benefit of priority from United Kingdom patent application number GB 2417382.5 filed on Nov. 27, 2024, the entire contents of which is incorporated herein by reference.

### BACKGROUND

### Technical Field

This disclosure relates to a spray nozzle, and in particular, to a spray nozzle for thermal spraying a coating material on a substrate. This disclosure further relates to a spray gun including a spray nozzle, a thermal spray apparatus, and a method for thermal spraying a coating material on a substrate.

### Description of the Related Art

High temperature components, such as gas turbine engine components, face increasing performance demands at higher temperatures and corrosive conditions. Such components may be coated with one or more barrier layers that provide protection against thermal flux, erosion, and/or environmental contamination. Barrier layers may be formed using a wide variety of production methods, including thermal spraying, vapor deposition, slurry deposition, electrophoretic deposition, or combinations thereof. Suitable thermal spraying techniques may include, for example, air plasma spraying, low pressure plasma spraying, suspension plasma spraying, high-velocity oxy-fuel (HVOF) spraying, etc.

Thermal spraying involves feeding a feedstock material into a heating zone, and the heated feedstock is transported towards a target surface of a substrate by a carrier gas in the form of a heated gas stream to form a coating on the target surface. Current thermal spraying equipment work effectively for powdered feedstock, allowing particles to be carried by the heated gas stream and get deposited on to the target surface. However, current equipment is unsuitable for suspension feedstock involving a liquid medium carrying fine particles, since there is a tendency for blockages in a nozzle of the thermal spraying equipment. In a powder-based system, the particles are dry and free-flowing, minimizing the risk of clogging. However, the suspension feedstock may accumulate and obstruct narrow passageways of the nozzle, thereby disrupting a flow of the suspension feedstock and the carrier gases triggering a flashback. This may lead to significant operational issues.

### SUMMARY

In a first aspect, there is provided a spray nozzle for thermal spraying a coating material on a substrate. The spray nozzle includes a central port configured to deliver the coating material along a spray axis in the form of an atomized suspension. The central port has an outlet diameter that is no greater than 0.75 millimeters. The spray nozzle further includes a plurality of gas ports arranged symmetrically and peripherally around the central port with respect to the spray axis. Each gas port of the plurality of gas ports is configured to deliver a pressurized combustible gas for entraining the coating material after the coating material has exited the central port. The pressurized combustible gas is configured to heat the coating material in a heating zone for generating a heated gas stream. The heated gas stream is directed toward a target surface of the substrate.

The spray nozzle of the present disclosure includes the central port for delivering the coating material in the form of the atomized suspension, and each gas port of the plurality of gas ports is arranged symmetrically and peripherally around the central port with respect to the spray axis. In some embodiments, the pressurized combustible gas delivered by the plurality of gas ports includes the oxy-fuel gas. Thus, the spray nozzle of the present disclosure integrates a suspension outlet within an oxy-fuel flame torch. This may ensure efficient mixing and combustion of the coating material, resulting in a stable and highly controlled heated gas stream. The central port is engineered to deliver a fine mist of the coating material.

The central port of the spray nozzle is strategically located at a geometric centre of the spray nozzle. Furthermore, the spray nozzle incorporates flow control mechanisms that may include precision valves and flow meters to meticulously regulate a delivery rate of the atomized suspension through a peristaltic pump. This precise control may maintain a consistent flow of the coating material for achieving optimal heating of the coating material.

In some embodiments, the pressurized combustible gas includes an oxy-fuel gas. Thus, the spray nozzle may form a part of an oxy-fuel flame torch and the oxy-fuel gas may be used for heating the coating material.

In some embodiments, the coating material includes yttria stabilized zirconia suspended in a non-flammable medium. Therefore, the spray nozzle may be able to thermally spray a sub-micron ceramic feedstock in the form of the atomized suspension on to the target surface of the substrate. In addition, a dense coating may be formed on the target surface of the substrate obtained with minimal wastage of the coating material.

The central port has an outlet diameter that is no greater than 0.75 millimeters. This size of the central port may be chosen for optimal deposition of the coating material. In some embodiments, the outlet diameter 134D of the central port 134 has an outlet diameter that is no greater than 0.70 mm, no greater than 0.65 mm, no greater than 0.60 mm, no greater than 0.55 mm, no greater than 0.50 mm, no greater than 0.45 mm, or no greater than 0.40 mm.

In some embodiments, the plurality of gas ports includes three gas ports. Each gas port of the three gas ports is arranged at a corresponding vertex of a triangle, such that a centroid of the triangle is disposed on the spray axis. Thus, the central port may be located at a geometric centre of the plurality of gas ports. This may ensure uniform coverage and effective interaction of the pressurized combustible gas with the atomized suspension, resulting in a stable and highly controlled heated gas stream.

In some embodiments, the plurality of gas ports includes four gas ports. Each gas port of the four gas ports is arranged at a corresponding vertex of a square, such that a centroid of the square is disposed on the spray axis. Thus, the central port may be located at the geometric centre of the plurality of gas ports. This may ensure uniform coverage and effective interaction of the pressurized combustible gas with the atomized suspension, resulting in a stable and highly controlled heated gas stream.

In some embodiments, the substrate is a component of a gas turbine engine. The component may be a high temperature component of the gas turbine engine and the spray nozzle may allow thermal spraying of the coating material on to the target surface of the component. This may enhance the performance of such components at higher temperatures.

In a second aspect, there is provided a spray gun. The spray gun includes the spray nozzle of the first aspect.

In some embodiments, the spray gun forms a part of an oxy-fuel flame torch.

In some embodiments, the spray gun further includes an additional port configured to deliver an additional material in the heating zone along an additional spray axis orthogonal to the spray axis. Thus, the spray gun may allow delivery of the additional material in the heating zone via the additional port. The additional material may form a part of the heated gas stream. Enabling hybrid deposition in this way may provide high efficiency multi-layered coatings.

In a third aspect, there is provided a thermal spray apparatus. The thermal spray apparatus includes the spray gun of the second aspect. The thermal spray apparatus further includes a coating material source configured to store the coating material. The thermal spray apparatus further includes a pump configured to deliver the coating material from the coating material source to the spray gun. The thermal spray apparatus further includes a gas source coupled to the spray gun and configured to supply the pressurized combustible gas to the spray gun. The thermal spray apparatus may allow the coating material to be deposited on the target surface of the substrate.

In a fourth aspect, there is provided a method for thermal spraying a coating material on a substrate. The method includes providing a spray nozzle including a central port and a plurality of gas ports arranged symmetrically and peripherally around the central port with respect to a spray axis. The central port has an outlet diameter that is no greater than 0.75 millimeters. The method further includes delivering, by the central port, the coating material in the form of an atomized suspension along the spray axis. The method further includes delivering, by the plurality of gas ports, a pressurized combustible gas for entraining the coating material after the coating material has exited the central port. The method further includes heating, by the pressurized combustible gas, the coating material in a heating zone for generating a heated gas stream. The method further includes directing the heated gas stream towards a target surface of the substrate.

In some embodiments, the pressurized combustible gas includes an oxy-fuel gas.

In some embodiments, the coating material includes yttria stabilized zirconia suspended in a non-flammable medium.

In some embodiments, the substrate is a component of a gas turbine engine.

As noted elsewhere herein, the present disclosure may relate to a gas turbine engine or more specifically to a spray nozzle for thermal spraying a coating material on a component of a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only with reference to the accompanying drawings, in which:

FIG. 1 shows a sectional side view of a gas turbine engine;

FIG. 2 shows a thermal spray apparatus including a spray gun;

FIG. 3 shows a perspective view of the spray nozzle of the thermal spray apparatus shown in FIG. 2 and a substrate;

FIG. 4 shows a perspective view of another embodiment of the spray nozzle and the substrate;

FIG. 5 shows a perspective view of another embodiment of the spray gun with an additional port; and

FIG. 6 is a flow chart of a method for thermal spraying a coating material on a substrate.

### DETAILED DESCRIPTION

Aspects and embodiments of the present disclosure will now be discussed with reference to the accompanying figures. Further aspects and embodiments will be apparent to those skilled in the art.

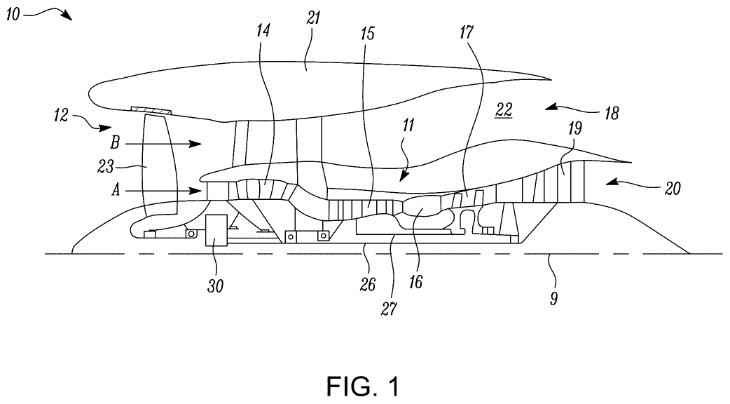

FIG. 1 illustrates a gas turbine engine 10 having a principal rotational axis 9. The gas turbine engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high pressure compressor 15, combustion equipment 16, a high pressure turbine 17, a low pressure turbine 19, and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the core exhaust nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

Note that the terms “low pressure turbine” and “low pressure compressor”, as used herein, may be taken to mean the lowest pressure turbine stages and lowest pressure compressor stages (i.e., not including the fan 23), respectively, and/or the turbine and compressor stages that are connected together by the interconnecting shaft 26 with the lowest rotational speed in the gas turbine engine 10 (i.e., not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

Other gas turbine engines to which the present disclosure may be applied may have alternative configurations. For example, such engines may have an alternative number of compressors and/or turbines and/or an alternative number of interconnecting shafts. By way of further example, the gas turbine engine 10 shown in FIG. 1 has a split flow nozzle 18, 20 meaning that the flow through the bypass duct 22 has its own nozzle 18 that is separate to and radially outside the core exhaust nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle), or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial, and circumferential directions are mutually perpendicular.

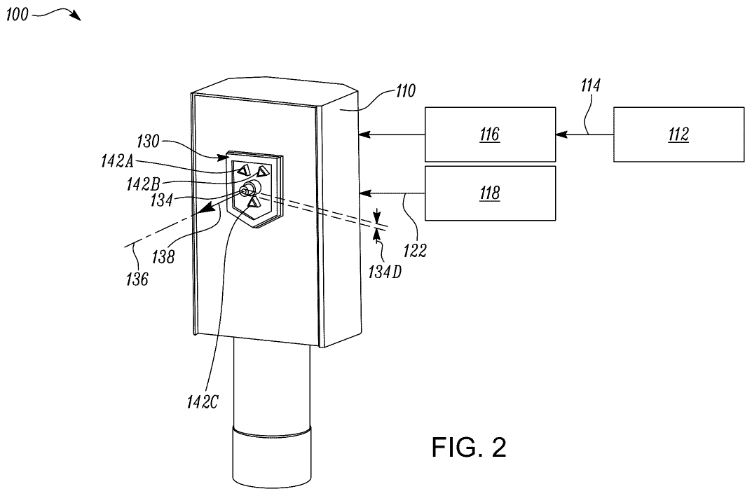

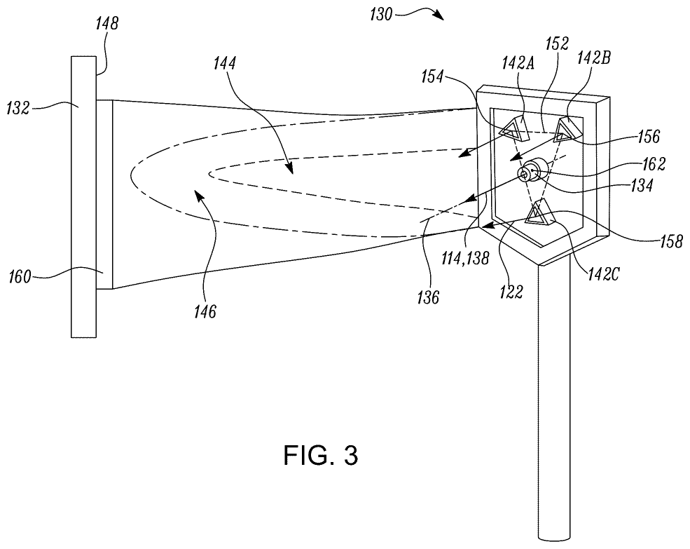

FIG. 2 shows a thermal spray apparatus 100. In some embodiments, the thermal spray apparatus 100 may be used for deposition of a coating on a substrate (e.g., a substrate 132 shown in FIG. 3). In some embodiments, the substrate is a component of the gas turbine engine 10 (shown in FIG. 1), e.g., blades, vanes, combustion tiles, turbine segments, etc. The coating may protect the component against thermal flux, erosion, and/or environmental contamination, e.g., by reducing or preventing Calcium-magnesium-alumino-silicate (CMAS) formation, migration, or infiltration. This may enhance the performance of the component at higher temperatures.

The thermal spray apparatus 100 includes a spray gun 110. The spray gun 110 includes a spray nozzle 130 for thermal spraying a coating material 114 on a substrate (e.g., the substrate 132 shown in FIG. 3). The thermal spray apparatus 100 further includes a coating material source 112 configured to store the coating material 114. In some embodiments, the coating material 114 includes a ceramic material. In some embodiments, the coating material 114 is in the form of a suspension. For example, the coating material 114 may include, e.g., yttria stabilized zirconia suspended in a non-flammable medium. The suspension may include fine particles with a particle size of about 5 micrometer (μm) to about 100 μm, or about 20 μm to about 80 μm, or about 22 μm to about 70 μm.

In some embodiments, the coating material source 112 may be located external to the spray gun 110 or on the spray gun 110. The thermal spray apparatus 100 further includes a pump 116 configured to deliver the coating material 114 from the coating material source 112 to the spray gun 110. For example, the spray gun 110 is coupled to the coating material source 112 via the pump 116 and the coating material 114 is delivered to the spray gun 110 by the pump 116. In some embodiments, the pump 116 may include a peristaltic pump.

The thermal spray apparatus 100 further includes a gas source 118 coupled to the spray gun 110 and configured to supply a pressurized combustible gas 122 to the spray gun 110. In some embodiments, the gas source 118 may be located external to the spray gun 110. In some embodiments, the pressurized combustible gas 122 includes an oxy-fuel gas. Specifically, the oxy-fuel gas may include an oxy-acetylene gas. However, other suitable combustible gases may also be utilized. For example, the combustible gas may include propane, methane, propylene, ethane, hydrogen. In some other embodiments, the combustible gas may include any volatile liquid fuel, such as kerosene.

In some embodiments, the thermal spray apparatus 100 may utilize a thermal spraying technique for deposition of the coating material 114. The thermal spraying technique may include High-Velocity Oxygen-Fuel (HVOF) spraying. Correspondingly, when the combustible gas is air enriched with oxygen, the thermal spraying technique is known as High-Velocity Air-Fuel (HVAF) spraying. It should be noted that other suitable thermal spraying techniques may also be utilized for deposition of the coating material 114, e.g., air plasma spraying, low pressure plasma spraying, suspension plasma spraying, etc.

The spray nozzle 130 includes a central port 134 configured to deliver the coating material 114 along a spray axis 136 in the form of an atomized suspension 138. In the illustrated embodiment of FIG. 2, the central port 134 has a circular cross-section. However, the central port 134 may have any cross-sectional shape, including elliptical cross-section, an irregularly shaped cross-section, etc. In some embodiments, the spray axis 136 coincides with a geometric centre of the central port 134. The central port 134 has an outlet diameter 134D that is no greater than 0.75 millimeters (mm). In some embodiments, the central port 134 has an outlet diameter 134D that is no greater than 0.70 mm, no greater than 0.65 mm, no greater than 0.60 mm, no greater than 0.55 mm, no greater than 0.50 mm, no greater than 0.45 mm, or no greater than 0.40 mm.

The spray nozzle 130 further includes a plurality of gas ports 142 arranged symmetrically and peripherally around the central port 134 with respect to the spray axis 136. In the illustrated embodiment of FIG. 2, the plurality of gas ports 142 includes three gas ports 142A, 142B, 142C. However, it should be noted that the spray nozzle 130 may include any number of the gas ports 142 arranged symmetrically and peripherally around the central port 134. Each gas port 142 of the plurality of gas ports 142 is configured to deliver the pressurized combustible gas 122 for entraining the coating material 114 after the coating material 114 has exited the central port 134. Specifically, the pressurized combustible gas 122 entrains the coating material 114 in the form of the atomized suspension 138. In some embodiments, the plurality of gas ports 142 may be arranged such that the pressurized combustible gas 122 exiting the plurality of gas ports 142 may be directed towards the coating material 114 exiting the central port 134 in the form of the atomized suspension 138.

FIG. 3 shows a perspective view of the spray nozzle 130 and the substrate 132. In some embodiments, the spray nozzle 130 may be used to coat a target surface 148 of the substrate 132. The substrate 132 may be suitable for use in a high-temperature environment. In some examples, the substrate 132 may include a ceramic or a ceramic matrix composite (CMC). Suitable ceramic materials, may include, e.g., a silicon-containing ceramic, such as silica (SiO₂) and/or silicon carbide (SiC); silicon nitride (Si₃N₄); alumina (Al₂O₃); an aluminosilicate; a transition metal carbide (e.g., WC, Mo₂C, TiC); a silicide (e.g., MoSi₂, NbSi₂, TiSi₂); combinations thereof; or the like. In some examples where the substrate 132 includes a ceramic, the ceramic may be substantially homogeneous. It should be noted that the substrate 132 may further include other materials, such as metal, plastic, glass, or the like.

In some embodiments, the substrate 132 may be further coated with one or more other coatings, e.g., a bond coat, a primer coat, a hard coat, a wear-resistant coating, another thermal barrier coating, an environmental barrier coating, an abrasive coating, an abradable coating, or the like. In some embodiments, the substrate 132 may include any regular or irregular shape, geometry, and/or configuration. It should be noted that the substrate 132 is shown in FIG. 3 by way of example only, and the shape, geometry, and/or configuration of the substrate 132 may vary based on application requirements.

In some embodiments, a composition of the coating material 114 may be based on a composition of the substrate 132. In some embodiments, the coating material 114 may include a sub-micron ceramic feedstock. Specifically, the coating material 114 includes yttria stabilized zirconia suspended in a non-flammable medium.

In some embodiments, the coating material 114 exiting the central port 134 in the form of the atomized suspension 138 is entrained by the pressurized combustible gas 122 exiting the plurality of gas ports 142A, 142B, 142C at high velocity. Each gas port 142A, 142B, 142C of the three gas ports 142A, 142B, 142C is arranged at a corresponding vertex 154, 156, 158 of a triangle 152. Specifically, the gas port 142A is arranged at the vertex 154, the gas port 142B is arranged at the vertex 156, and the gas port 142C is arranged at the vertex 158 of the triangle 152. Further, it may be noted that a centroid 162 of the triangle 152 is disposed on the spray axis 136. Furthermore, a geometric centre of the central port 134 may also coincide with the spray axis 136.

The pressurized combustible gas 122 is configured to heat the coating material 114 in a heating zone 144 for generating a heated gas stream 146 (or a plume). The heated gas stream 146 is directed towards the target surface 148 of the substrate 132. Specifically, the pressurized combustible gas 122 exiting the plurality of gas ports 142 at high velocity allows the heated gas stream 146 to be directed towards the target surface 148 of the substrate 132. The heated coating material 114, i.e., molten or softened coating material 114, propelled by the plume may then contact the target surface 148 of the substrate 132. Upon impact, the molten or softened coating material 114 adheres to the target surface 148, resulting in a coating 160. Arrangement of the central port 134 and the plurality of gas ports 142A, 142B, 142C may ensure uniform coverage and effective interaction of the pressurized combustible gas 122 with the atomized suspension 138, resulting in a stable and highly controlled heated gas stream 146.

In some embodiments, the coating material 114 may include a relatively narrow particle size distribution that may allow uniform heating of the coating material 114 in the heating zone 144 and acceleration into the heated gas stream 146. In some embodiments, a substantially constant feeding rate of the coating material 114 may provide a uniform thickness to the coating 160, thereby improving a coating quality.

The thermal spray technique (e.g., HVOF spraying) utilized by the spray nozzle 130 may allow deposition of ceramic coatings that possess good adhesion with the target surface 148, due to the associated high temperature or high velocity, offering superior diffusion and strong bonding, respectively. In addition, a dense coating is formed on the target surface 148 of the substrate 132 obtained with minimal wastage of the coating material 114.

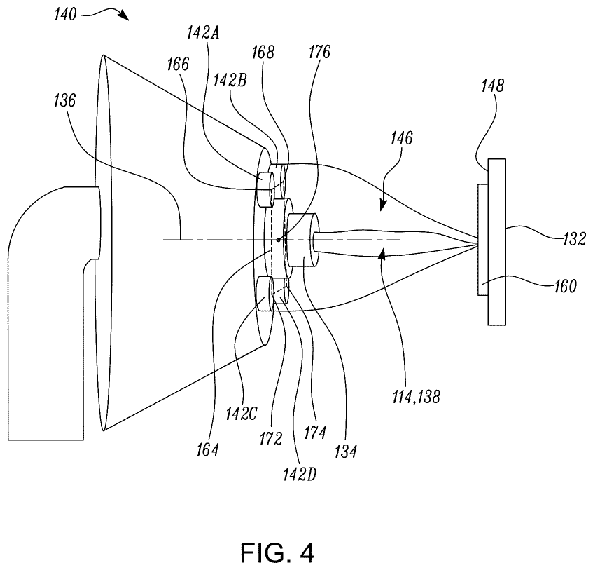

FIG. 4 shows a perspective view of another embodiment of the spray nozzle 140. The spray nozzle 140 is functionally similar to the spray nozzle 130 of FIGS. 2 and 3 with same components being referred to by same reference numerals and only and only differences between the embodiments are described.

In some embodiments, the plurality of gas ports 142 includes four gas ports 142A, 142B, 142C, 142D. Each gas port 142A, 142B, 142C, 142D of the four gas ports 142A, 142B, 142C, 142D is arranged at a corresponding vertex 166, 168, 172, 174 of a square 164. Specifically, the gas port 142A is arranged at the vertex 166, the gas port 142B is arranged at the vertex 168, the gas port 142C is arranged at the vertex 172, and the gas port 142D is arranged at the vertex 174 of the square 164. Further, it may be noted that a centroid 176 of the square 164 is disposed on the spray axis 136. Furthermore, a geometric centre of the central port 134 may also coincide with the spray axis 136. The four gas ports 142A, 142B, 142C, 142D are arranged symmetrically and peripherally around the central port 134 with respect to the spray axis 136. This may ensure uniform coverage and effective interaction of the pressurized combustible gas 122 (shown in FIGS. 2 and 3) with the atomized suspension 138, resulting in a stable and highly controlled heated gas stream 146.

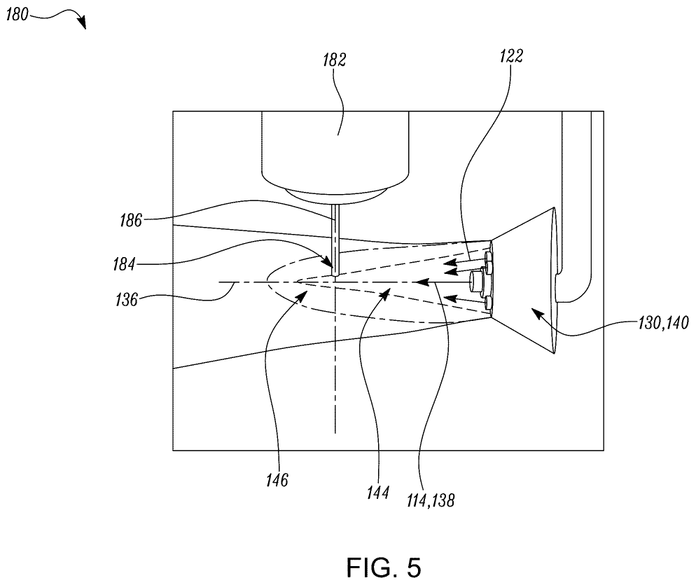

FIG. 5 shows a perspective view of a spray gun 180 with an additional port 182. The spray gun 180 is functionally similar to the spray gun 110 shown in FIG. 2 with same components being referred to by same reference numerals and only and only differences between the embodiments are described.

The spray gun 180 includes the spray nozzle 130, 140. In the illustrated embodiment of FIG. 5, the spray gun 180 further includes an additional port 182 configured to deliver an additional material 184 in the heating zone 144 along an additional spray axis 186 orthogonal to the spray axis 136. Further, the spray nozzle 130, 140 delivers the coating material 114 in the form of the atomized suspension 138 and the pressurized combustible gas 122 to the heating zone 144. The coating material 114 and the additional material 184 may be simultaneously heated in the heating zone 144 to generate the heated gas stream 146. The heated gas stream 146 is then directed towards a substrate (not shown). This may allow multiple materials to be utilized for coating the substrate. In some embodiments, the additional material 184 may be in the form of an atomized suspension or a powder.

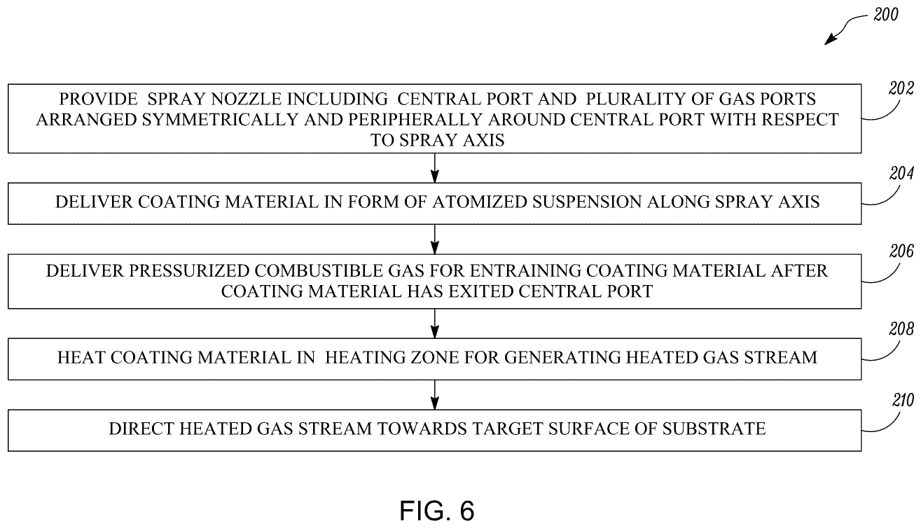

FIG. 6 shows a method 200 for thermal spraying the coating material 114 (shown in FIGS. 2-4) on the substrate 132 (shown in FIGS. 2-4B), in accordance with some embodiments of the present disclosure. The method 200 shall be described with reference to FIGS. 1-5.

Referring to FIGS. 2-6, at step 202, the method 200 includes providing the spray nozzle 130, 140 including the central port 134 and the plurality of gas ports 142 arranged symmetrically and peripherally around the central port 134 with respect to the spray axis 136. The central port 134 has the outlet diameter 134D that is no greater than 0.75 mm.

At step 204, the method 200 further includes delivering, by the central port 134, the coating material 114 in the form of the atomized suspension 138 along the spray axis 136. In some embodiments, the coating material 114 includes yttria stabilized zirconia suspended in a non-flammable medium.

At step 206, the method 200 further includes delivering, by the plurality of gas ports 142, the pressurized combustible gas 122 for entraining the coating material 114 after the coating material 114 has exited the central port 134. In some embodiments, the pressurized combustible gas 122 includes an oxy-fuel gas.

At step 208, the method 200 further includes heating, by the pressurized combustible gas 122, the coating material 114 in the heating zone 144 for generating the heated gas stream 146.

At step 210, the method 200 further includes directing the heated gas stream 146 towards the target surface 148 of the substrate 132. In some embodiments, the substrate 132 is a component of the gas turbine engine 10.

Referring to FIGS. 1-6, the spray nozzle 130, 140, according to the present disclosure, includes the central port 134 for delivering the coating material 114 in the form of the atomized suspension 138, and each gas port 142 of the plurality of gas ports 142 is arranged symmetrically and peripherally around the central port 134 with respect to the spray axis 136. In some embodiments, the pressurized combustible gas 122 includes the oxy-fuel gas. Thus, the spray nozzle 130, 140 of the present disclosure integrates a suspension outlet within an oxy-fuel flame torch. This may ensure efficient mixing and combustion of the coating material 114, resulting in a stable and highly controlled heated gas stream 146. The central port 134 is engineered to deliver a fine mist of the coating material 114.

The central port 134 of the spray nozzle 130, 140 is strategically located at a geometric centre of the spray nozzle 130, 140. Furthermore, the spray nozzle 130, 140 incorporates flow control mechanisms that may include precision valves and flow meters to meticulously regulate a delivery rate of the atomized suspension 138 through the pump 116. This precise control may maintain a consistent flow of the coating material 114 for achieving optimal heating of the coating material 114.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

Various examples have been described, each of which comprise one or more combinations of features. It will be appreciated by those skilled in the art that, except where clearly mutually exclusive, any of the features may be employed separately or in combination with any other features and the invention extends to and includes all combinations and sub-combinations of one or more features described herein.

We claim

1. A spray nozzle for thermal spraying a coating material on a substrate, the spray nozzle comprising:
a central port configured to deliver the coating material along a spray axis in the form of an atomized suspension, the central port having an outlet diameter of no greater than 0.75 millimeters; and
a plurality of gas ports arranged symmetrically and peripherally around the central port with respect to the spray axis, wherein each gas port of the plurality of gas ports is configured to deliver a pressurized combustible gas for entraining the coating material after the coating material has exited the central port, the pressurized combustible gas is configured to heat the coating material in a heating zone for generating a heated gas stream, and the heated gas stream is directed toward a target surface of the substrate.

2. The spray nozzle of claim 1, wherein the pressurized combustible gas comprises an oxy-fuel gas.

3. The spray nozzle of claim 1, wherein the coating material comprises yttria stabilized zirconia suspended in a non-flammable medium.

4. The spray nozzle of claim 1, wherein the outlet diameter of the central port is no greater than 0.70 millimeters.

5. The spray nozzle of claim 4, wherein the outlet diameter of the central port is no greater than 0.65 millimeters.

6. The spray nozzle of claim 5, wherein the outlet diameter of the central port is no greater than 0.60 millimeters.

7. The spray nozzle of claim 1, wherein the plurality of gas ports comprises three gas ports, and each gas port of the three gas ports is arranged at a corresponding vertex of a triangle, such that a centroid of the triangle is disposed on the spray axis.

8. The spray nozzle of claim 1, wherein the plurality of gas ports comprises four gas ports, and each gas port of the four gas ports is arranged at a corresponding vertex of a square, such that a centroid of the square is disposed on the spray axis.

9. The spray nozzle of claim 1, wherein the substrate is a component of a gas turbine engine.

10. A spray gun including the spray nozzle of claim 1.

11. The spray gun of claim 10, wherein the spray nozzle forms a part of an oxy-fuel flame torch.

12. The spray gun of claim 10, further comprising an additional port configured to deliver an additional material in the heating zone along an additional spray axis orthogonal to the spray axis.

13. A method for thermal spraying a coating material on a substrate, the method comprising:
providing a spray nozzle comprising a central port and a plurality of gas ports arranged symmetrically and peripherally around the central port with respect to a spray axis, the central port having an outlet diameter that is no greater than 0.75 millimeters;
delivering, by the central port, the coating material in the form of an atomized suspension along the spray axis;
delivering, by the plurality of gas ports, a pressurized combustible gas for entraining the coating material after the coating material has exited the central port;
heating, by the pressurized combustible gas, the coating material in a heating zone for generating a heated gas stream; and
directing the heated gas stream towards a target surface of the substrate.

14. The method of claim 13, wherein the pressurized combustible gas comprises an oxy-fuel gas.

15. The method of claim 13, wherein the coating material comprises yttria stabilized zirconia suspended in a non-flammable medium.

16. The method of claim 13, wherein the substrate is a component of a gas turbine engine.
